(19) United States
(12) Patent Application Publication
(10) Pub. No.: US 2022/0154890 A1
(43) Pub. Date: May 19, 2022

(54) CHEMICAL DISTRIBUTION APPARATUS AND METHOD

(71) Applicant: Tab Fowler, Cedar Park, TX (US)

(72) Inventor: Tab Fowler, Cedar Park, TX (US)

(21) Appl. No.: 16/950,125

(22) Filed: Nov. 17, 2020

(51) Int. Cl. F17D 3/12

(52) U.S. Cl. CPC F17D 3/12

(57) ABSTRACT

The first aspect of the instant claimed device is a system of equipment allowing addition of solid materials to a pipeline wherein said solid material is conveyed in such a way as to be readily dissolved by the liquid in said pipeline, comprising: (a) a solid material storage container which acts as a material feeder; (b) feed pipe to convey fluid from a connected pipe to said solid material; (c) and means for holding said solid material in place for a sufficient length of time such that the liquid in said process pipeline can contact and dissolve said solid material and carry it in the fluid downstream of the process pipeline.

### FIELD OF THE INVENTION

This invention relates generally to a system of equipment and methods of using same for addition of solid materials to a pipeline.

### BACKGROUND OF THE INVENTION

Different types of equipment to add materials to pipelines are known in the art of materials handling. Some of this equipment is commercially available while others of this type of equipment exist only in laboratory and pilot plant operations.

See U.S. Pat. No. 3,353,723 which describes and claims a rotary valve for batching and charging loose materials, for instance granular, chipped or otherwise comminuted substances, into a container under internal pressure.

Also see U.S. Pat. No. 4,828,145 which describes and claims a rotary-type metering device making it possible to dispense granular substances consisting of fine particles which are difficult to handle. The metering device consists of a spherical core rotating around a horizontal axis inside a casing comprising a feed orifice and an outlet orifice.

Also see U.S. Pat. No. 4,687,381 which describes and claims a device and process for introducing a powder with catalytic activity into a fluidized bed polymerization reactor.

When the liquid is compressed air, a reference describing an automatic drain system is U.S. Pat. No. 4,058,240 which describes an automatic drain system for compressed air systems, air dryers, aftercoolers, separators and the like, which eliminates the loss of compressed air and is not clogged by sediment in the accumulated liquid or slurry.

it would be desirable to have a system of equipment that provided for the addition of solid materials to a pipeline, that also provided for optimal contact of the solid material with the liquid in the pipeline and also permitted addition of solid materials to a pipeline.

### SUMMARY OF THE INVENTION

The first aspect of the instant claimed device is a system of equipment allowing addition of solid materials to a pipeline wherein said solid material is conveyed in such a way as to be readily dissolved by the liquid in said pipeline, comprising:
(a) a solid material storage container which acts as a material feeder;
(b) feed pipe to convey fluid from a connected pipe to said solid material;
(c) and means for holding said solid material in place for a sufficient length of time such that the liquid in said process pipeline can contact and dissolve said solid material and carry it in the fluid downstream of the process pipeline.

### BRIEF DESCRIPTION OF THE DRAWINGS

FIG. 1A is a perspective view of the apparatus.

FIG. 1B is a perspective view of the apparatus.

FIG. 2 is a perspective view of the apparatus.

FIG. 3 is a perspective view of the apparatus.

FIG. 4 is a perspective view of the apparatus.

### DETAILED DESCRIPTION OF THE INVENTION

The instant claimed device is a system of equipment allowing addition of solid materials to a pipeline wherein said solid material is conveyed in such a way as to be readily dissolved by the liquid in said pipeline, comprising:
(a) a solid material storage container which acts as a material feeder;
(b) feed pipe to convey fluid from a connected pipe to said solid material;
(c) and means for holding said solid material in place for a sufficient length of time such that the liquid in said process pipeline can contact and dissolve said solid material and carry it in the fluid downstream of the process pipeline.

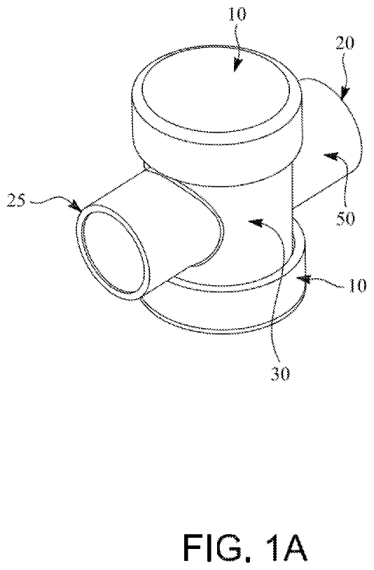

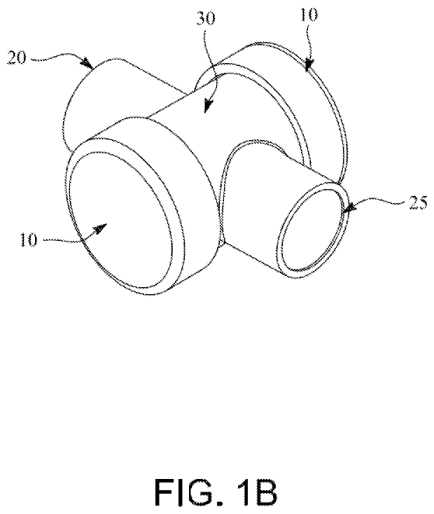

The system of equipment for feeding solid materials to a pipeline, one embodiment of which is shown in FIGS. 1A and 1B, has been found useful for handling solid materials that are available in most types of geometric shapes such as round shapes, granule, solid chemicals, or powders. In FIGS. 1A and 1B the device is shown with two end caps, 10, on opposites sides of a chemical feed pipe, 30. The is a fluid pipe, 50, with an inlet side, 20, and an outlet side, 25, wherein a fluid enters from the inlet side, 20, and exits from the outlet side, 25. The end caps, 10, can be screwed on. Alternatively, the end caps, 10, can be bolted, screwed, latched, sealed with adhesives, or otherwise attached to the chemical feed pipe, 30, so that they can be removed or left in place as desired. Additionally the end caps, 10, can be permanently welded or attached in place.

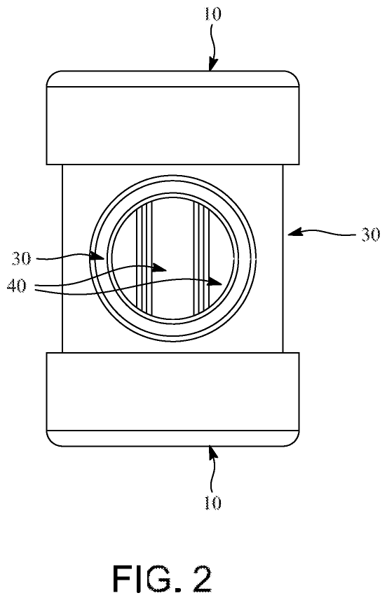

FIG. 2 shows a side view of a the first embodiment of the device wherein a set of chemical restraining bars, 40, in the feed pipe, 30, prevent the solid chemicals from exiting the feed pipe, 30, and entering the fluid pipe, 50. The end caps, 10, prevent pressure in the feed pipe, 30, or fluid pipe, 50, from forcing the solid chemical from exiting the feed pipe, 30.

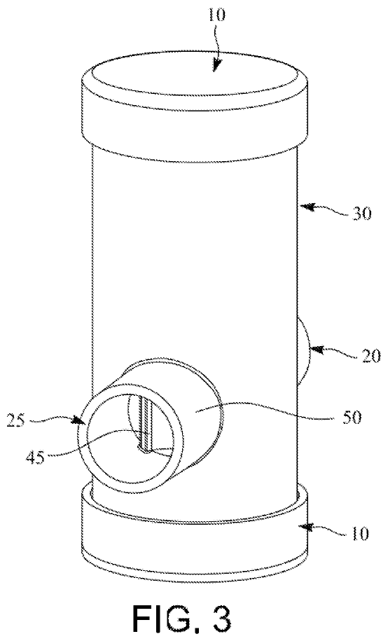

FIG. 3 is a perspective view of a second embodiment of the device. The end caps, 10, are attached to the feed pipe, 30. The fluid pipe, 50, has an inlet side, 20, and an outlet side, 25. The fluid pipe, 30, has restraining bars, 45, that prevent the solid chemicals from entering the fluid pipe, 30.

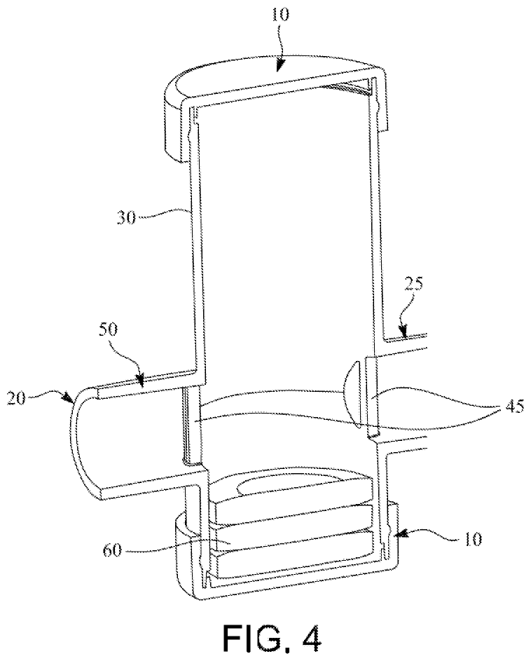

FIG. 4 is an interior perspective view of the second embodiment of the device. The end caps, 10, are attached to the feed pipe, 30. The fluid pipe, 50, has an inlet side, 20, and an outlet side, 25. The fluid pipe, 30, has restraining bars, 45, that prevent the solid chemicals, 60, from entering the fluid pipe, 30.

These embodiments still allow a fluid to pass over, around, and dissolve the solid chemicals, 60, in the feed pipe, 30. The amount of time, chemicals used, and other criteria for selecting the solid chemicals, 60, will depend on the size of pipes used, size and geometry of the solid chemicals, 60, used, the desired effect the chemicals are supposed to have, and the type of fluids used in the pipes, 30 and 50.

For purposes of this patent application, the word “pellet” and the phrase “solid material” are to be taken to mean the same thing. Solid chemicals can have many shapes, though oftentimes they are rounded or spherical or use some combination of round and straight geometry, such as a cylinder with rounded ends. For use with the system of this equipment, the solid chemicals may be, but do not have to be, rounded or spherical or cylindrically shaped with rounded ends. The type of preferred solid chemicals for an application will be dependent on the fluids in the pipes, the temperature and pressure of those fluids, and the chemical it is desired to add to the fluid. The solid chemicals can be anywhere from about 1/16 inch to at least 3 feet in diameter depending on the application and desired solid chemicals to be used.

Pipe used in the system can be made of any suitable material of construction for industrial pipe from rigid metal or plastic pipe to flexible plastic or rubber hose. The preferred configuration is a rigid metal or plastic, PVC, pipe. Suitable metal pipes include pipes made out of stainless steel, brass, copper, aluminum, steel, galvanized and black pipe. Suitable plastic pipes include EPDM (ethylene-propylene-diene-methylene) copolymer. PVC (polyvinyl chloride), CPVC (chlorinated polyvinyl chloride), polypropylene, PVDF (polyvinylidene fluoride), TFE (tetrafluoroethylene) and TFE PFA (tetrafluoroethylene perfluoroalkoxy). The preferred material for the device used in this system of equipment is PVC. PVC pipe is available commercially from many different sources including Ryan-Herco Inc., 1155 Frontenac Rd., Naperville Ill. 60563, (630)369-1141.

The feed pipe can be any commercially available container that meets the requirements for holding and dispensing the solid material of choice. It also can be fashioned out of available materials, such as PVC pipe that has had a top lid fastened at one end of the pipe and a means for delivering the solid chemicals to the solid material pellet feeder attached to the bottom end of the pipe. One suitable means for delivering solid chemicals to feed pipe, and from there to the fluid in the fluid pipe, is a rotating plate (not shown) with holes in it, wherein the plate rotates a certain number of holes at a time in response to instructions relayed either manually or by using some sort of mechanical or electronic controller.

Solid chemicals, such as pellets, powders, or other material to be added to the fluid in the fluid pipe are deposited in the feed pipe by removing one or both endcaps using any standard fastening technique such as screw on, latched, bolted, adhesive, or other attachment means.

Solid chemicals are exposed to the fluid as it passes by and are slowly dissolved by the fluid. The chemicals in the solid chemicals then enter the remainder of the pipe and are used to remove scale, rust, mold, and other undesirable organic and inorganic items that are deposited by normal operation of a pipe. This device can be installed on AC units, water drainage pipes, Ice machines drainpipes, water service pipes, and any other pipe carrying a fluid or gas.

Suitable materials for a vertical or horizontal feed and fluid pipes are any rigid or flexible pipe. The preferred type of material is rigid PVC pipe. The pipe may be of any size such that the ID of the feed pipe is equal to or larger than the OD of the fluid pipe. Most fluid pipes have and OD of ⅛ inch to 5 feet in and the feeder pipes much have an ID that is at least equal to the OD of the fluid pipes.

The feed pipe is configured and operated in such a way as to ensure that the correct amount of solid chemicals is fed to the fluid. The can be either by manual, mechanical operation of the feed pipe (push a button, one pellet falls) or it can be of sophisticated operation such as accepting an electronic signal from a controller which is monitoring all aspects of an industrial water system, including the need for more of the solid material to be added to the pipeline.

While the present invention is described above in connection with preferred or illustrative embodiments, these embodiments are not intended to be exhaustive or limiting of the invention. Rather, the invention is intended to cover all alternatives, modifications and equivalents included within its spirit and scope, as defined by the appended claims.

What is claimed is:

1. A device comprising:
a pipe with a first inner diameter and a first outer diameter;
a second pipe with a second inner diameter and a second outer diameter wherein the second inner diameter is at least equal to, or larger, than the first outer diameter
a first and second hole in the first pipe wherein the first and second hole are opposite to each other;
a third and fourth hole in the second pipe that are opposite to each other such that the first pipe fits in and through the second pipe wherein the first hole is approximately ninety degrees from the third hole in one direction along a central axis and the first hole is approximately ninety degrees from the fourth hole in a second direction along a central axis and the second hole is approximately ninety degrees from the third hole in one direction along a central axis and the second hole is approximately ninety degrees from the fourth hole in a second direction along a central axis wherein all four holes form a circle along one axis wherein each hole is approximately ninety degrees from the adjacent holes on either side; wherein
the second pipe is long enough to hold solid chemicals within the second pipe wherein a bar, mesh, screen, or other means is used to prevent the solid chemicals from passing from the second pipe into the first pipe;
the first pipe has a fluid or gas passing through it wherein the fluid or gas can pass through the first and second holes and into the second pipe through the third and fourth holes to dissolve the sold chemicals in the second pipe and wherein the fluid will contain dissolved particles of the solid chemicals and the fluid will then flow and carry the dissolved particles into the second hole and exit the device.
